(19) United States
(12) Patent Application Publication
(10) Pub. No.: US 2014/0091752 A1
(43) Pub. Date: Apr. 3, 2014

(54) USB Charging System

(71) Applicant: EVER WIN INTERNATIONAL CORPORATION, City of Industry, CA (US)

(72) Inventor: Arthur L. Serrano, West Hills, CA (US)

(73) Assignee: Ever Win International Corporation, City of Industry, CA (US)

(21) Appl. No.: 13/630,182

(22) Filed: Sep. 28, 2012

(51) Int. Cl. H02J 7/00

(52) U.S. Cl. 320/107

(57) ABSTRACT

A dual USB port charging system that can charge at 2.1 A and also at 1 A at the same time when the power supply is only capable of 10 W. A USB port is set as a 2.1 A port via resistor network. If nothing is connected to the other USB port, it charges at 2.1 A. If a device is connected to the other USB port, it automatically detects this condition and momentarily interrupts the 5V output while resetting the USB port to 1 A (the resistor network is changed to 1 A spec). Both devices will then charge at 1 A. If the second device is disconnected while the first device is still charging at 1 A, the charging system will interrupt the output momentarily and reset the network back to 2.1 A. The first device re-registers and is now able to charge at 2.1 A again. If the second USB device is connected first while the first USB port is unused it will also set both ports as 1 A. As the standard USB port is switched between 1 A and 2.1 A network, the current limit is also automatically switched from 1 A to 2.1 A.

### BACKGROUND

1. Field of Invention

The present invention relates generally to USB chargers. More specifically, the present invention relates to a USB charging system that is capable of outputs through multiple universal serial buses to charge one or more electronic devices.

2. Description of Related Art

Most modern electronic devices consume substantial amount of electrical energy to perform its complex and multiple functions. The electrical energy is generally provided by a battery enclosed within the electronic device. The battery may be a disposable battery but more commonly, it is a rechargeable battery. The rechargeable battery must be recharged with a direct current source when it is depleted.

Chargers are commonly used to convert household 110V alternating current to direct current to power and recharge electronic devices. Universal serial bus (USB) ports are also commonly used to provide direct current to recharge electronic devices. The rechargeable battery in an electronic device is recharged by electrically connecting it to the direct current output of the charger or the USB port. A standard USB port is capable of supplying 1 A at 5V for a total power of 5 W.

Apple USB charge specification for iPad, iPod, and iPhone specifies that a resistor network be placed on the USB D+ and D− data lines. This network tells the device what current is available from the USB power source. If the resistor network is setup such that R1 is 43.2 k, R2 is 49.9 k, R3 is 75 k, and R4 is 49.9 k then the iPad will charge at 2.1 A maximum. If R1 is 75 k, R2 is 49.9 k, R3 is 43.2 k, and R4 is 49.9 k then it will charge at 1A max. These resistors can be present on the D+/− signals of a USB connector or can be placed directly on the 30 pin dock instead. Electronic devices such as the iPod and iPhone only require 1 A to efficiently charge their battery. However, an iPad requires 2.1 A to efficiently charge its battery.

For a power supply with dual USB ports that can charge two iPad devices at the same time at 2.1 A each, it must be capable of sourcing a total of 21 W. Also, if an iPad plus an iPhone or iPod are connected to the two ports, then the supply must be capable of 15.5 W.

Therefore, there exists an unfulfilled need for a USB charger with dual output to be able to charge both at 1 A and also at 2.1 A through its USB ports when the power supply is only capable of 10 W.

### BRIEF SUMMARY OF THE INVENTION

The present invention is a dual output power USB charging system that can charge at 2.1 A and also at 1 A at the same time when the power supply is only capable of 10 W. In one embodiment, a USB port is set as a 2.1 A Apple port via resistor network. If nothing is connected to the other USB port, it charges the iPad at 2.1 A. If a device is connected to the other USB port, it automatically detects this condition and momentarily interrupts the 5V output while resetting the USB port to 1 A (Apple resistor network is changed to 1 A spec). Both devices will then charge at 1 A. If the second device is disconnected while the iPad is still charging at 1 A, the charging system will interrupt the output momentarily and reset the Apple network back to 2.1 A. The iPad re-registers and is now able to charge at 2.1 A again. If the USB device is connected first while the USB port is unused it will also set both ports as 1 A. As the standard USB port is switched between 1 A and 2.1 A Apple network, the current limit is also automatically switched from 1 A to 2.1 A.

### BRIEF DESCRIPTION OF THE DRAWINGS

FIG. 1 shows the circuit for the USB charging system using the analog method.

FIG. 2 shows the circuit for the USB charging system using the analog method with the preferred values for the circuit components.

FIG. 3 shows the circuit for the USB charging system using the MCU controlled method.

FIG. 4 shows the circuit for the USB charging system using the MCU controlled method with the preferred values for the circuit components.

FIG. 5 shows the preferred embodiment of an AC/DC power source with the preferred values for the circuit components.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

This invention allows a 10 W supply to support two iPads or an iPad and an iPod or iPhone allowing each device to charge at a predictable current. For example, if a single iPad is connected to USB port #1, the resistor network will be set at 2.1 A and the iPad will charge at 2.1 A max. If another device (iPad, iPod, or iPhone) is connected to USB port #2, then both USB port resistor networks will be changed from 2.1 A to 1 A allowing each device to charge at 1 A. To do this the power supply must interrupt its output before changing the networks to allow the original iPad to ‘re-register’ the new charge condition. The default condition, without any devices connected, sets each port to 2.1 A resistor network. For the invention to operate, it must detect the presence of two devices. It can do this task in two ways.

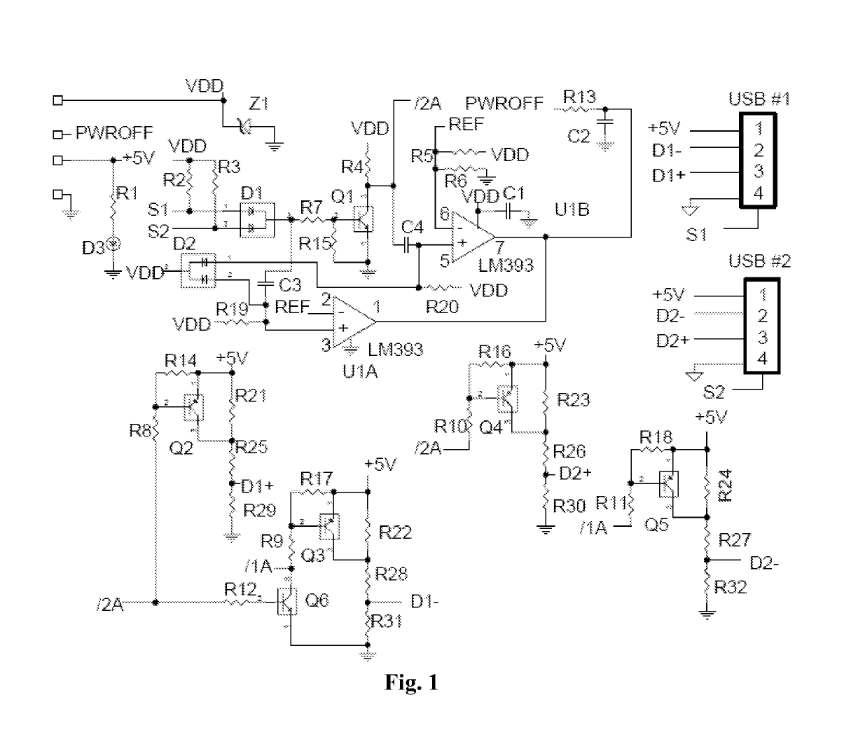

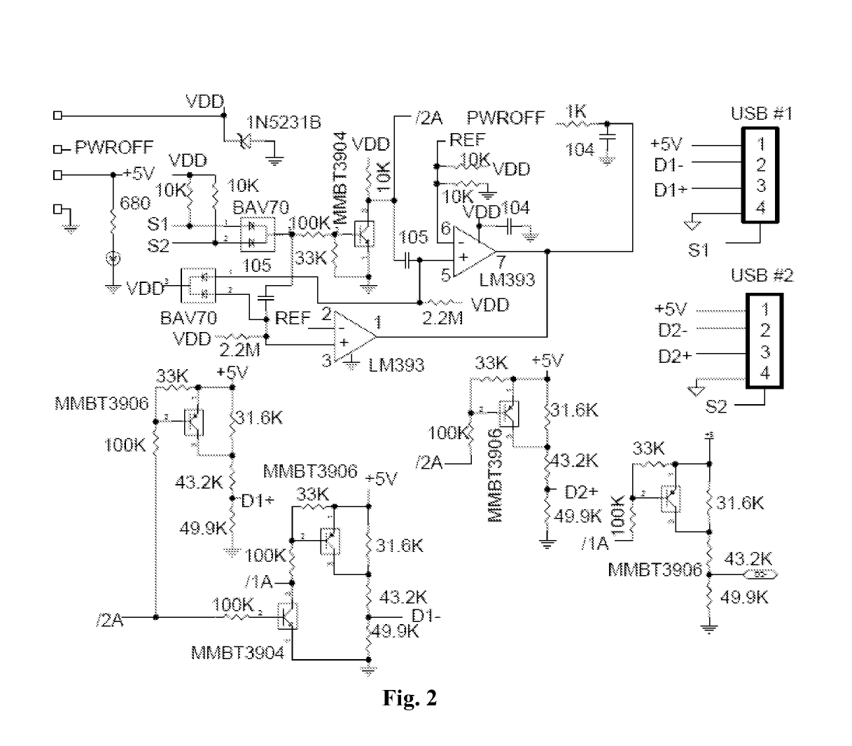

One preferred embodiment is the analog method shown in FIGS. 1 and 2. The standard Apple USB to dock connector cable includes a wire that connects the USB metal frame to the dock connector metal frame. When the Apple device is connected to the dock connector its internal power ground signal is shorted to the frame, which in turn makes the USB frame also ground. If the corresponding frame contact on the USB port is pulled up by a resistor to +5V, then the signal labeled S1 goes from +5V to 0V when the Apple device is connected. The same applies to the second port and the signal S2.

On initial power up, each port is setup per the 2.1 A specification. S1 and S2 are both +5V. The signal /2 A is set to 0. This turns on Q2 via R8, which shorts out R21. The resistance from D1+ to +5V becomes 43.2 k Ohms. With /2 A at 0, Q6 is turned off which also turns off Q3, making the resistance from D1− to +5V equal to approximately 75 k Ohms (43.2 k+31.6 k=74.8 k). The same applies to D2+/− networks.

If only one device is connected to either USB port 1, S1 goes to 0. If the device is connected to port 2, S2 goes to 0. Either one of these conditions do not change the status quo. In order for the circuit status to change, both S1 and S2 must be low (indicating two devices are connected). When S1 and S2 are low, this causes a negative pulse (+5V to 0V) at U1A+ input and a 0V pulse at its output pin 1. This signal (PWROFF) going low turns off the +5V supply for about 1 second. At the same time with both S1 and S2 at 0V, /2 A signal becomes +5V. This causes Q2 to turn on, shorting R21 and setting the D1+ resistance to +5V at 75 k Ohms. Also, /2 A at +5V turns on Q6 which in turn turns on Q3. This makes the resistance from D1− to +5V to be 43.2 k Ohms. The same applies to D2+/− networks. Thus, both USB ports are set to 1 A.

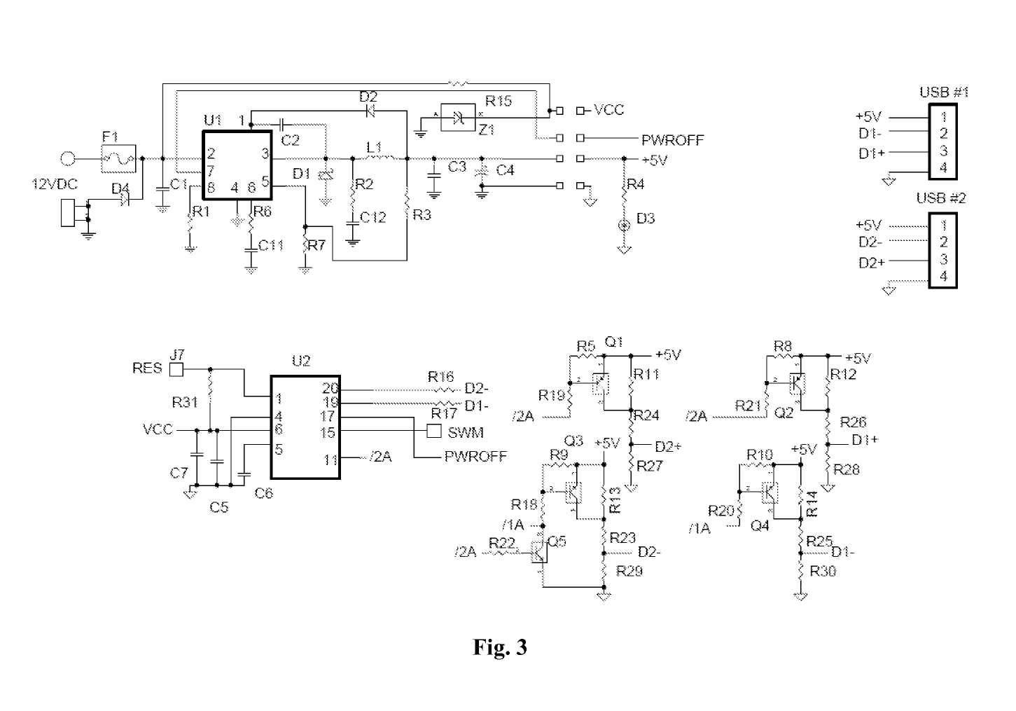

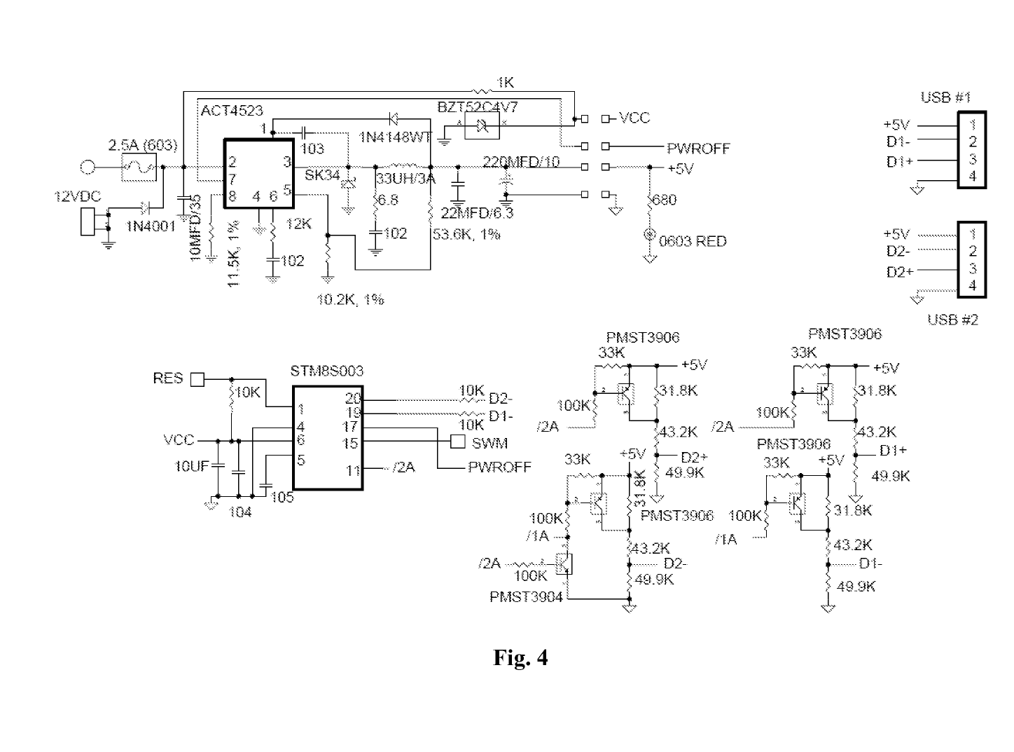

When either or both devices are unplugged from the USB ports, S1 or S2 or both go high making signal /2 A via Q1 low again and the default state of 2 A is reached once more. Simultaneously, a negative pulse is created at U1B+ input, causing the output pin 7 to go low. This sets PWROFF low once again and the +5 volt output is interrupted once again. The comparator U1 is never turned off as it is powered directly VDD (also +5V) which is regulated directly from the 12 VDC input, as shown in FIGS. 3 and 4, and it is independent of the main +5V power supply.

The above method also applies to the case where an iPad is connected to one port and a non-Apple device (such as a smartphone or an Android tablet) is connected to the other port. As long as the USB frame is grounded by the cable used with the non-Apple device, the two port condition will be detected and the iPad will be charged at 1 A instead of 2.1 A.

Another embodiment is the MCU controlled method shown in FIGS. 3 and 4. This method uses a microcontroller to detect the presence of two devices and does not require the use of a grounded frame cable.

The basic procedure is the same as in the analog method. The system defaults with 2.1 A resistor network in each USB port. The behavior of the /2 A signal is the same. The difference in this method is how the MCU (U2) detects the presence of the device connected to each USB port. Two MCU A/D inputs (pins 19 and 20) monitor the voltage change of D1− and D2− signals. By default D1− and D2− are biased at +2.7V by the resistor networks. When a device is connected, this voltage changes depending on the type of device. When it drops below a predetermined threshold, the device is detected. When two devices are detected, the MCU sets the /2 A signal high setting both ports to 1A. The MCU also sets PWROFF momentarily high to interrupt the USB +5V output. When one or both devices are removed, the MCU reads the D− voltage change, interrupts power once again, and resets the networks to 2.1 A.

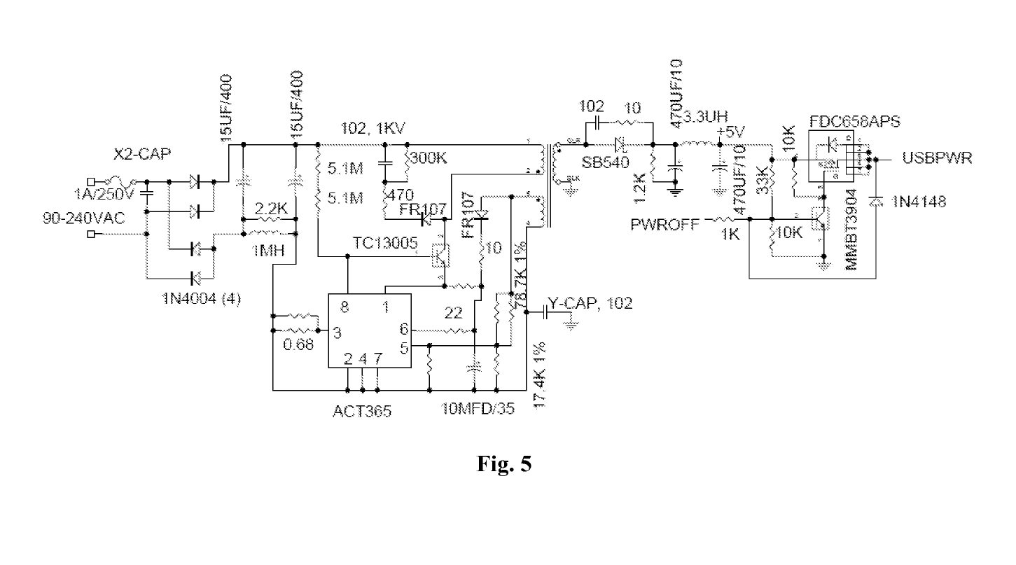

Both embodiments above use a DC/DC+5V supply as the power source. This supply can also be an AC/DC power source shown in FIG. 5. In this case the power on/off control is done by a power FET transistor connected to the USB power lines of both USB ports. The FET circuit can be used in both Analog and MCU methods. In the default state the PWROFF signal is +5V. This turns on Q3, which in turn sets the FET get low shorting the source (S) to the drain (D). This applies power to both USB ports. When PWROFF goes low, Q3 is turned off which turns off the FET and power is removed from the USB ports.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A USB charging system comprising the steps of:
providing two USB ports each with a predetermined voltage and a predetermined current;
detecting if a device is connected to each of the two USB ports;
resetting each USB port to provide a different current if a device is connected to each of the two USB ports; and
continuing to provide each USB port with said predetermined voltage and predetermined current if only one device is connected to one of said USB ports.

2. A USB charging system as in claim 1, wherein said predetermined voltage is +5V, said predetermined current is 2.1 A, and said different current is 1 A.

3. A USB charging system as in claim 1 further comprising providing a direct current to the USB charging system to power the two USB ports.

4. A USB charging system as in claim 1 further comprising providing a alternating current to the USB charging system to power the two USB ports.

5. A USB charging system as in claim 3 wherein a power FET transistor switches the power to the USB ports.

6. A USB charging system comprising the steps of:
providing two USB ports each with a predetermined voltage and a predetermined current;
providing a microcontroller unit to detect voltage changes in the system; and
changing each USB port to provide a different current upon detecting a voltage drop in both USB ports.

7. A USB charging system as in claim 6, wherein said predetermined voltage is +5V, said predetermined current is 2.1 A, and said different current is 1 A.

8. A USB charging system as in claim 6 further comprising providing a direct current to the USB charging system to power the two USB ports.

9. A USB charging system as in claim 6 further comprising providing a alternating current to the USB charging system to power the two USB ports.

10. A USB charging system as in claim 6 wherein a power FET transistor switches the power to the USB ports.
